(19) United States
(12) Patent Application Publication
(10) Pub. No.: US 2007/0201933 A1
(43) Pub. Date: Aug. 30, 2007

(54) Feeding system for image forming machine

(76) Inventors: NamJeon Park, Anyang-si (KR); YunJoo Moon, Sungnam-si (KR); DongMin Kim, Seoul (KR); JungMi Oh, Seoul (KR); ByungChul Kyun, Uiwang-si (KR); SoonJae Moon, Kwangmyung-si (KR); JunHo Lee, Anyang-si (KR)

Correspondence Address: KIMBERLY-CLARK WORLDWIDE, INC., 401 NORTH LAKE STREET, NEENAH, WI, 54956, US

(21) Appl. No.: 11/362,300

(22) Filed: Feb. 24, 2006

(51) Int. Cl. B41J 15/00

(52) U.S. Cl. 400/611; 400/617

(57) ABSTRACT

There is provided a feeding system for an image forming machine using a first feeder roll and a press roll that form a nip between them though which a substrate is passed, and a second feeder roll located after a printing zone, where the first and second feeder roll surfaces move at the same speed.

### BACKGROUND OF THE INVENTION

Wide format printing machines are used for printing complex patterns on various substrates like paper, films, nonwoven fabrics, woven cotton, canvas, silk, polyester, nylon, Lycra® and other materials. These printers or image forming machines are capable of producing images on substrates having widths of greater than about 36 inches (910 mm) at relatively high speeds. Such large scale applications include the creation of images on mattress covers and bedspreads, automotive fabrics, upholstery, architectural applications, signs and banners and the like.

Wide format image forming machines generally have a plurality of printing heads mounted above the substrate and move across the substrate, perpendicular to the direction of motion of the substrate. As the printing heads move from side to side across the substrate, they deposit colorant (typically in the form of an ink or dye) to form an image in a predetermined pattern, conventionally controlled by a computer system.

The shear size of the image forming machine used in wide-width printing presents the user with a variety of technical problems. Existing substrate feeding systems, for example, can result in substrate stretching, misalignment, wrinkling, and colorant bleeding as the substrate is feed over plates and between pinch rolls during the printing process. Improper drying of the substrate can result in smearing of the colorant on the substrate or on parts of the image forming machine. In addition, current systems also have difficulty in adapting to substrates of varying thicknesses. Current image forming machines are able to adapt to variations in thickness of up to about 1 mm from the machine's built in or pre-set thickness capability because the printing head is moved vertically to accommodate thicker substrates and the range of this movement is limited.

The complexity of these image forming machines presents another challenge to the designer as modifications and changes to existing systems must be capable of fitting into relatively small spaces. In addition, certain types of printing heads are quite fragile and must be treated with the utmost care lest they be damaged. The close tolerances required in the making of such machines allow for the creation of high quality images, but make successful modification of the machine quite difficult.

It is an object of this invention to provide an image forming system that reduces substrate stretching, misalignment, wrinkling, and bleeding and so improves the quality of the printed substrate produced.

### BRIEF DESCRIPTION OF THE FIGURES

FIG. 1 is a diagram of an image forming machine feed system having the feeding system of this invention.

FIG. 2 is an image of the feeding system from a closer vantage point than that of FIG. 1.

### SUMMARY OF THE INVENTION

The inventors have found that feeding accuracy and stability are improved with a continuous substrate feeding system that uses commonly driven rollers or gears to convey the substrate. In this manner, stretching and other negative effects are reduced and the quality of the printed image can be improved.

Other features and aspects of the present invention are discussed in greater detail below.

### DETAILED DESCRIPTION

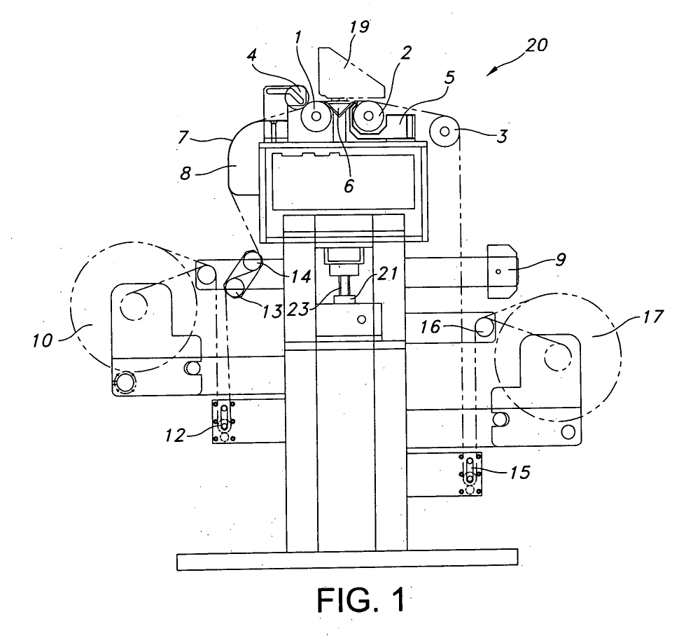

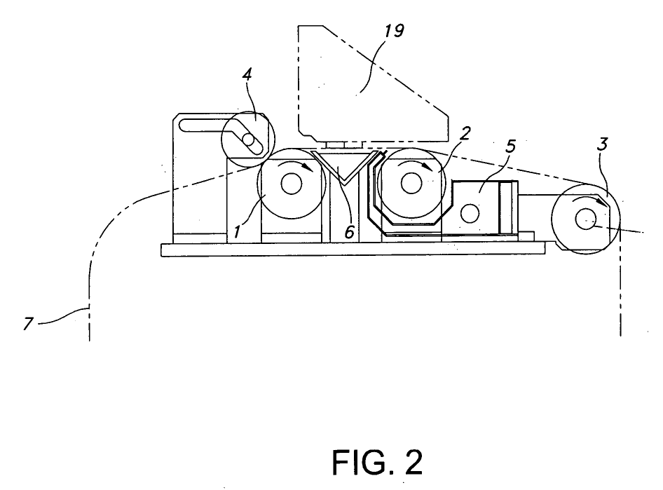

Turning to FIG. 1 one can see that the feeding system 20 of the invention includes at least two feeder rolls (1, 2) and optionally a third feeder roll 3, as well as a press roll 4 arranged around an ink tray 6 located in the printing zone. The printing zone is the area where the printing head unit 19 travels perpendicularly to the direction of movement of the substrate (the machine direction or MD). FIG. 1 shows the invention in the X and Y planes and the movement of the printing head is in the Z direction (the cross-machine direction or CD). FIG. 2 is an image of the feeding system 20 from a closer vantage point.

The substrate 7 is taken from a supply roll 10 around various guide rollers 11 and around a rack and pinion roll 12, though this may vary based on the needs of the user. The rack and pinion roll 12 serves as one means of controlling tension by moving vertically as needed in response to the tension sensed in the substrate. From the rack and pinion roll 12 the substrate may pass between a pair of tension rolls 13, 14 which not only rotate individually but may rotate as a pair about a common axis in order to provide an additional means of controlling the substrate tension.

Upon leaving the tension rolls 13, 14 the substrate 7 may pass around a rounded plate 8 and into the pinch or nip between the driven first feeder roll 1 and the un-driven press roll 4. Since the press roll 4 is un-driven, it moves only because of friction with the substrate 7 which is moved by the driven feeder rolls. As the substrate 7 moves from left to right in FIG. 1, it then passes into the printing zone; the location of the ink tray 6 as mentioned above, and on to the second feeder roll 2, which is also driven. The substrate is printed in the printing zone. Conventionally, this first point of contact between the now-printed substrate and another object (the second feeder roll 2) is the point at which un-dried colorant may be smeared and damage the quality of the substrate (in substrate not having a backing). As the substrate 7 moves, heated air may optionally be directed upward toward the substrate 7 from the dryer 5 to dry the colorant sufficiently. After passing over the second feeder roll 2 the substrate 7 passes above the dryer 5 (if present) and to the optional third feeder roll 3.

The substrate 7 may move directly from the second feeder roll to a wind-up operation or the third feeder roll 3, if present, may send the substrate 7 to the wind-up operation which may vary depending on the needs of the user. As shown in FIG. 1, the substrate 7 passes near an infrared heater 9 to finish the drying step completely and then passes another tension controlling rack and pinion roll 15 and around another guide bar 16 before going to a take-up roll 17.

The image forming machine may optionally include a means for controlling the location of the edge of the substrate. This functions through the use of position sensors and limit sensors that inform a computer of the location of the substrate in relation to the image forming machine. In response to indications that the substrate edge is not in the proper position, a positioning means (e.g. manual adjustment or electric, pneumatic, or hydraulic motor) may move the supply roll 10 from side to side to realign the edge.

In wide format printing, the image quality depends very greatly on the ability to precisely control the web location. A 720 dot per inch (dpi) printer, for example, requires being able to control the web position precisely and accurately to within 35 microns in the MD direction. It is important, therefore, that the surfaces of the first, second and third (if present) feeder rolls 1, 2, 3 move at the same speed (and in the same direction). One way to ensure that the three feeder rolls move at the same speed, is to provide them with the same diameter and connect them by pulleys mounted on their shafts and driving belts (or chain) or alternatively by gears desirably driven by a common (shared) motor. This the one way in which the substrate may be maintained in a stable an accurate orientation while being printed upon.

The printers or image formers are desirably digital textile printing machines with a roll to roll configuration as distinguished from the higher speed printers known in the art and utilizing a blanket printing configuration. Wide format printing substrates generally are desired to be printed at a speed between 1 and 30 meters per hour, more particularly between 5 and 20 meters per hour and this is the desired surface speed of the feeder rolls.

In one example, the feeder roll drive motor may be located between the second and third feeder rolls 2, 3, with the motor shaft aligned with (parallel to) the shafts of the feeder rolls 1, 2, 3. Conventional continuous flexible driving belts may extend from a pulley on the motor shaft around a similar pulley on the shaft of one or more of the feeder rolls. If the belt extends around only one or two of the feeder rolls, another driving belt may connect a pulley on the shaft of (one on the driven feeder rolls with a pulley on the undriven feeder roll(s) or to a pulley on the motor shaft. Thus the feeder system may use one single driving belt connecting the motor and all of the feeder rolls or it may use as many driving belts as there are feeder rolls (three in this example) each extending from the motor or from an adjacent driven roll. In this example, all of the feeder rolls and feeder roll pulleys have the same diameter.

In another example, the feeder rolls or feeder roll pulleys may have different diameters. In this case, the sizing of the pulleys and feeder rolls must be calculated to result in the surfaces of the feeder rolls moving at the same speed. In yet another example, each feeder roll may be provided with a separate motor directly connected to each respective roll. A combination of techniques may also be used. Whether using pulleys, gearing, separate motors or a combination thereof, however, it is important that the surfaces of the feeder rolls move in the same direction at the same speed.

It is also desirable that the press roll 4 be as heavy as practical and coated with a lower hardness material than the feeder rolls 1, 2, 3 in order to eliminate slippage and prevent wrinkles. It is still more desirable that the distance between the nip between the press roll 4 and the first feeder roll 1 to the next feeder roll 2 be as short as possible. If this distance is large, the difference in percent shrinkage between the wet and dry parts of the substrate can cause wrinkling. In the practice of the invention, the inventors have found that feeder rolls and a press roll made from nitrile rubber (NBR or butadiene acrylonitrile) are satisfactory though other materials may be used.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A feeding system for an image forming machine comprising a first feeder roll and a press roll having surfaces that form a nip between them though which a substrate is passed, and a second feeder roll having a surface and located after a printing zone, wherein said substrate passes from the first feeder roll, through the printing zone and to the second feeder roll, and wherein said first and second feeder roll surfaces move at the same speed.

2. The feeding system of claim 1 wherein said first and second feeder roll surfaces move at the same speed because they are driven by a common motor and are connected by driving belts or a gear system.

3. The feeding system of claim 1 wherein said rolls are made from butadiene acrylonitrile.

4. The feeding system of claim 1 further comprising a third feeder roll having a surface to which the substrate passes after said second feeder roll.

5. The feeding system of claim 4 wherein the surface of said third feeder roll surface moves at the same speed as said first and second feeder rolls.

6. The feeding system of claim 1 wherein said first and second feeder roll surfaces move at a speed between 1 and 30 meters per hour.

7. The feeding system of claim 6 wherein said first and second feeder roll surfaces move at a speed between 5 and 20 meters per hour.
